(19) United States
(12) Patent Application Publication
(10) Pub. No.: US 2008/0011235 A1
(43) Pub. Date: Jan. 17, 2008

(54) Pet food tray

(76) Inventors: Magdalena Bahnean, Modesto, CA (US); Avram Bahnean, Modesto, CA (US)

Correspondence Address: QUAN LE NGUYEN;CHANDLER & UDALL, LLP, 4801 E. BROADWAY BLVD., SUITE 400, TUCSON, AZ, 85711-3609, US

(21) Appl. No.: 11/485,888

(22) Filed: Jul. 13, 2006

(51) Int. Cl. A01K 5/01

(52) U.S. Cl. 119/61.5

(57) ABSTRACT

A novel pet food tray is disclosed-comprising of a housing with openings for receiving pet food dishes, where the housing is configured with three lobes with an opening in each lobe, the three openings being in triangular relation to each other. The dishes are affirmatively engageable with the housing and can be removed and reinstalled.

In an alternate embodiment of the present invention, the food dishes are part of an integrated pet food product where the food dish is comprised of a sealed container of prepared pet food that is compatible with installation of the container into the housing of the pet food tray.

### CROSS REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The present invention relates to a pet food tray. More particularly, the present invention relates to a pet food tray with a replaceable dish portion comprising multiple replaceable dishes.

There have been long standing problems with the presentation of food to domestic pets. The usual situation involves a cat or a dog, although other pets such as rabbits and pot bellied pigs have become more popular over time as well and the teachings of the present invention would easily apply in these cases as well. Notwithstanding, the experience with dogs and cats and the placement of their food has proven that if given the chance, the pet is likely to create a mess by scattering food while eating (or even playing) or even overturning the food dish and distributing the contents. The typical pet owner will often purchase a conventional dish for use in presenting the pet food to the pet. These dishes are of a common shape and resemble soup bowls although sometimes the bases of the dish are widened to provide some additional stability and to resist the tendency of dishes to be overturned by the pet. In any event, the typical dish of this type is inadequate when it comes to providing protection against the spread of the pet food and for resistance against tipping or overturning when confronting a persistent pet.

In addition, the typical pet food dish is dedicated to just one food offering. For instance, the owner will typically supply the pet with at least a dry food and water. Sometimes the pet owner will offer the pet a third option such as a moistened food or a supplemental food. Given the fact that the conventional dish will only be able to hold one food at a time (without otherwise causing the mixing of the food or water) this requires the pet owner to supply two or three different dishes. Unfortunately this takes up floor space and very often becomes a nuisance factor as the dishes may get underfoot and the owner may accidentally cause the dishes to tip or overturn, thereby increasing the frustration levels in dealing with the handling and management of pet food.

There are different types of pet food trays and dishes known in the prior art, including U.S. Pat. No. 5,501,176 (Tully) where a pet food stand is provided with two dishes that are insertable into a tray. The tray is height adjustable. The Tully pet food stand does not provide the enhanced stability that would prevent the tipping and/or overturning of the pet food receptacles and this remains a problem. The dishes in Tully are merely held in place through gravity. In U.S. Pat. No. 2,584,301 (Sinclair) a tray for presenting two pet food dishes is taught where the wire tray frame is rectangular and orients the food dishes in side-by-side fashion. Sinclair does have extended legs that will provide some outboard stability, however, the there still is instability transverse to the long axis of the tray frame. In addition, the food dishes are set within the tray frame and are maintained there by gravity. There is no affirmative means in Sinclair to retain the dishes in place.

Similarly, in U.S. Design Pat. No. D312,896 (Goetz) a design for a dual compartment feeding dish is shown. Side-by-side designs are also shown in U.S. Design Pat. No. D244,947 (Gerber), and in U.S. Design Pat. No. D491,697 (Tsengas). These dishes are all typified by the side-by-side design that results in an elongate dish body that is somewhat rectangular (or elliptical) in overall geometry. These dishes present with a long axis crossed by a short axis, leading to potential instability in the direction of the short axis. In addition, there is no indication in any of the designs that replaceable dish inserts are available. All of these designs appear to function identically and do not suggest the benefits of the present invention.

Lastly, in U.S. Pat. No. 5,564,363 (Soffici) a pet food dish of the side-by-side type is taught with a special anti-insect barrier that runs along the perimeter of the top of the dish. The anti-insect barrier operates using a flow of water that circulates along the perimeter. Other than this feature, the side-by-side design of the Soffici dish is functionally identical to the prior art side-by-side dishes.

Even though pet feeding dishes have been the focus of inventive efforts, there still remains the long standing problems associated with the disruption of the food dishes, the containment of the pet food within the dishes, as well as other desired objectives that have not been addressed at all. Some of these additional goals would include the desire to maintain the cleanliness of the dishes used for pet food, finding a convenient way to serve more than two pet food products in the same vehicle, and providing a pet food tray that integrates with the containers for prepared pet food offerings. These attributes and other features and benefits of the present invention will be discussed in more detail below and will be shown in the drawings.

### SUMMARY OF THE INVENTION

A novel pet tray for presenting food to a domestic pet, the pet food tray comprising a housing with places for three (or more) food dishes where the dishes are replaceably insertable into the housing. The housing is generally configured with three lobes in a triangular relation, just short of approximating an equilateral triangle. The housing has height with a top and bottom, and an identified front and back, and includes a tray lip that extends about the perimeter of the housing top and serves to prevent pet food from being discharged from the pet food tray.

Further enhancements on the present invention include the use of dishes that snap fit into engagement within the places allocated for them within the housing. The dishes may, in an alternate form of the present invention, comprise the container for a prepared pet food product that can be installed into the housing and then later discarded when the contents of the dish have been consumed.

These and other attributes and functions of the present invention will be shown and discussed in more detail below.

### BRIEF DESCRIPTION OF THE DRAWINGS

FIG. 1 is an isometric view of the pet food tray of the present invention with three food dishes installed.

FIG. 2 is an isometric view of the pet food tray of FIG. 1, with two food dishes shown as suspended above their respective openings for installation within the housing, and with the third dish shown as having been partially removed from its location in one of the openings provided for the dish within the housing.

FIG. 3 is what will be termed a “rear” elevational view of the pet food tray of FIG. 1.

FIG. 4 is a side cross sectional view of the pet food tray of FIG. 1, taken along Section Lines 4-4.

FIG. 5 is a side elevational view of the pet food tray of the present invention as would be used by a pet such as the dog shown in the drawing.

### DETAILED DESCRIPTION OF THE PREFERRED EMBODIMENTS

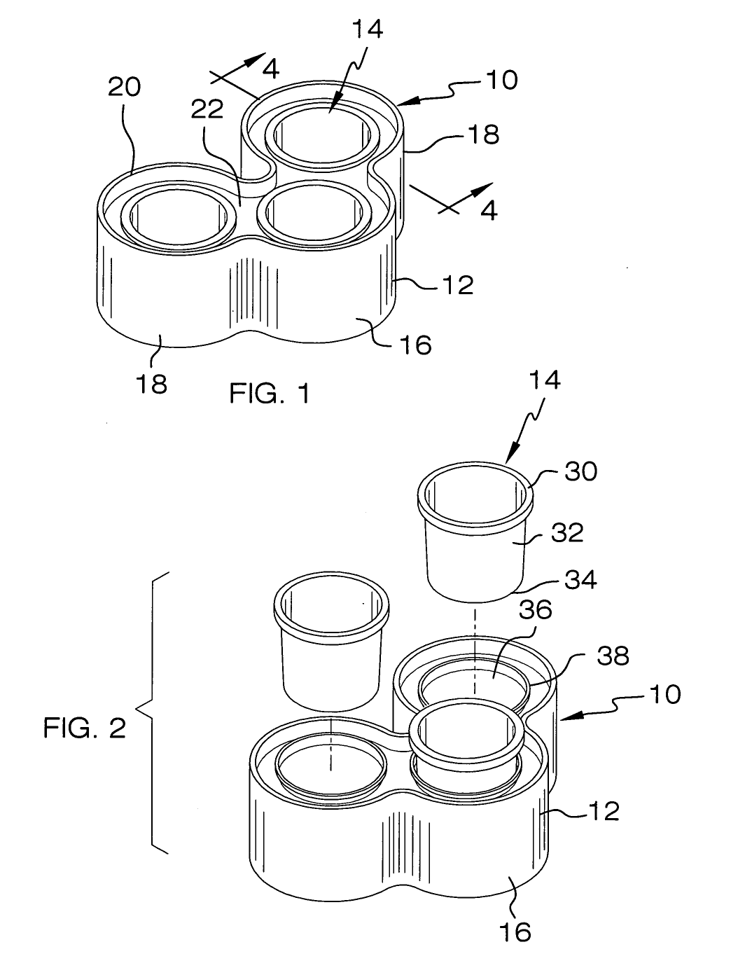

A new pet food tray in accordance with the present invention is shown in the drawings and can initially be understood in FIGS. 1 and 2, where the pet food tray 10 is comprised of the housing 12, the food dishes 14, the tray front 16, the tray lobes 18, the tray lip 20 and the tray web 22. The dishes 14 each include a dish lip 30, a dish body 32, where the dishes 14 fit into the dish openings 36 and are seated onto the dish collar 38.

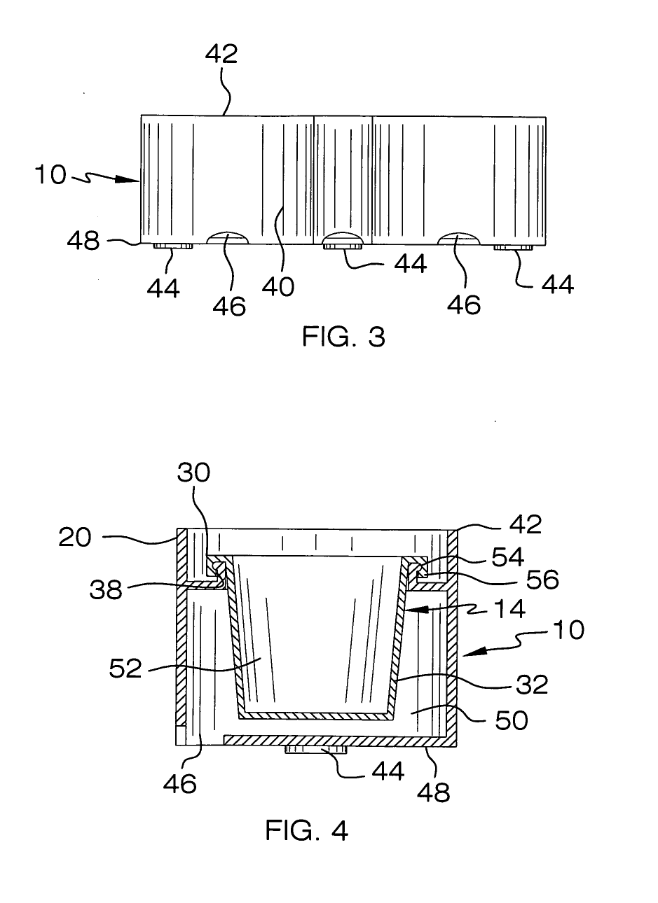

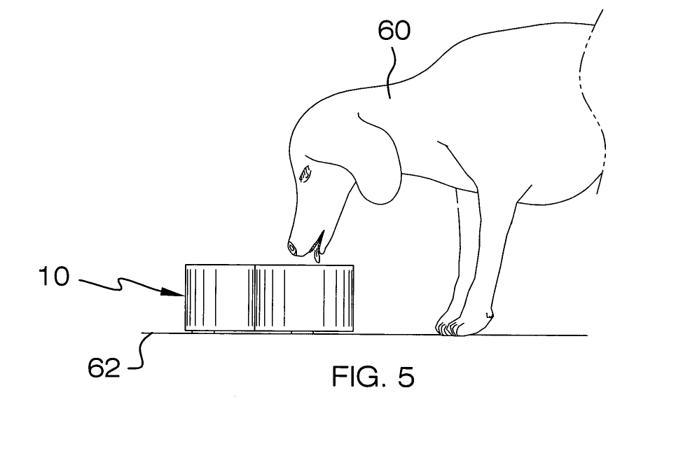

More details of the pet food tray of the present invention are seen in FIGS. 3 and 4, where the pet food tray 10 is shown from the rear 40, and includes the tray top 42, feet 44, finger holes 46 and the tray bottom 48. It can also be seen that the dish collar 38 includes an outer edge 54 that extends for the perimeter of the dish collar 38. Extending from the perimeter of the dish lip 30 is the lip edge 56. Additional components of the pet food tray 10 can be seen in FIG. 4 as the tray interior 50 and the dish interior 52. Lastly, in FIG. 5 an example of the use of the pet food tray 10 of the present invention is shown with pet (dog) 60 shown as eating from the pet food tray 10 where it sits on the floor 62.

The pet food tray of the present invention provides multiple dishes for presentation to the user's pet in a manner that is more organized and less likely to create a mess than any of the dishes or trays known in the prior art. Commencing with the design of the housing, it can be understood from the drawings that it is shaped to have three lobes in which each food dish resides. Each of the lobes comprises sidewalls that integrally form the housing, where the housing is sized vertically to be able to receive the food dishes. The lobes are arranged in a triangular fashion where the center point of the dish opening in each lobe, when referenced with the others, describes three axis's that would representationally resemble a triangle of such dimensions that it would be close but not quite equal to an equilateral triangle. Using the nomenclature of the “front” and “rear” for the tray as defined above, the axis that would be associated with the rear would be slightly longer than the axis's associated with the other two sides of the representational triangle.

The configuration of the housing in the triangular fashion imparts increased stability that has not been shown before in pet trays or dishes of this kind. The pet food tray of the present invention is resistant to being tipped or overturned since there is no short axis in any direction that can be easily overcome as has been the case for other tray and dish designs.

The dishes of the present invention have a novel contribution to the pet food tray. The dish lip has a lip edge that extends downwardly thus forming a space between the lip edge and the dish body. Similarly, the dish collar, located on the housing top, has an outer edge that projects outwards from the dish collar. When the dish is inserted onto the dish collar, the lip edge and the outer edge will become engaged as shown in FIG. 4 and will cause the dish to be affirmatively retained to the housing. This is important since it allows the dishes to be independently removed from the housing for cleaning, filling or for replacement.

The housing of the pet food tray also preferentially incorporates finger holes near the bottom of the housing, which are sized so that the pet owner can use his/her finger tips to grip the pet food tray, allowing it to be lifted and transferred from place to place as may be needed. The housing also has feet applied on the bottom where the feet are preferably formed from a rubber-like material that provides some gripping action when the housing is sitting on a surface such as the floor.

The tray lip located about the perimeter of the housing imparts a function as well. The tray lip extends above the tray web and helps to guard against any of the pet food from being discharged from the pet food tray. Additionally it provides a point for an upper grip when the user is engaging the finger holes, the user may also engage the tray lip with his/her finger tips as well assuring the user of an even firmer hold on the product.

The dishes of the present invention are shown in a configuration that suggests a height/width ratio. It is noted that the configuration of the dish, other than the structural elements described herein, is free to be altered to fit the needs or desires of the pet owner. Thus dishes may be configured so they are wider and less deep, or in any other combination, in order to meet the requirements of the pet and the user. It is contemplated, however, that the dishes may comprise a part of an integrated package where the pet food tray is able to use commercial containers of pet food directly without having to transfer the food from one a to the dish. Obviously this would require that the pet food containers conform to the requirements of the pet food tray and would be compatible with placement in the dish openings and engagement between the lip edge and the outer edge.

The advantage of being able to purchase compatible dishes for the pet food tray is that fresh portions of pet food can be easily provided. This would be the case for both dry food and the moistened food that are offered, since even dry food can lose nutritional value the longer it remains exposed to open air conditions that occur after the bag has been opened. The food portions in each dish would be protected by a covering (not shown) which would typically consist of a plastic film that would be removed by the pet owner just prior to installing the dish into the housing and into the dish opening. Cleanup is simply the reverse, the removal of the dish from the housing and disposing it. This way the pet is not exposed to the buildup of bacteria or molds by virtue of a dish that is remains the same source for the pet's food day after day. The replaceable dishes of the present invention therefore offer a higher degree of sanitation than has previously been shown in the art.

Whether or not the dishes are part of an integrated package with a pet food container, the replacement potential gives the pet owner the ability to remove the dish for cleaning whenever desired. The removed dish can be placed in a dishwasher and then re-inserted for use in the housing in the same manner as described above.

The components of the pet food tray are preferably formed from plastic injection molding the dishes and the housing. Plastics can be selected that will perform as housings and will be strong enough to withstand the duty service that a pet food dish would be contemplated to receive. The dishes are preferably manufactured from a plastic that has some resilience so as to allow the dish to be flexible enough to be inserted into the dish opening and for the lip edge and the outer edge to be engaged. The lip edge would essentially be fitted around the outer edge. In the alternate, the housing could be fabricated from a formed metal which would also meet the duty and service requirements discussed above. If the metal of choice was a stainless steel, the ability to maintain the housing in a clean condition would be enhanced.

It is understood that variations on the embodiments disclosed herein may be made without departing from the spirit and scope of the present invention. The teachings of the pet food tray are meant to be illustrative of its use and are not meant to represent limitations on the scope of the invention.

We claim:

1. A pet food tray for presenting food to a domestic pet, the pet food tray comprising:
Dishes for holding pet food; and,
A housing with three lobes with dish opening in each lobe where the dish openings compatibly receive three dishes in spaced triangular relation to each other, the housing further including a top and a bottom and sidewalls.

2. The pet food tray of claim Number 1, where the food dishes are affirmatively engageable with the housing.

3. The pet food tray of claim Number 1, where the housing includes a tray lip formed around the perimeter of the top of the housing to inhibit the loss of pet food from the pet food tray.

4. The pet food tray of claim Number 2, where the dishes include a dish body and a dish lip, where the dish body is insertable into a dish opening in the housing, where the housing includes a dish collar formed about the perimeter of dish opening, and where the dish lip is fittable onto the dish collar and the dish is thereafter retained to the housing.

5. The pet food tray of claim Number 4, where the dish lip further includes a lip edge and the dish collar further includes an outer edge, where the dish lip forms a space between the dish lip and the dish body and where said dish is engaged with the outer edge of the dish collar by fitting the lip edge around the outer edge and thereby affirmatively retaining the dish collar within said space.

6. The pet food tray of claim Number 1, where the dishes are comprised of sealed containers of prepared pet food products that are compatibly installable in the dish openings in the housing.

7. A pet food tray for presenting food to a domestic pet, the pet food tray comprising:
Dishes for holding pet food; and,
A housing with three lobes with dish opening in each lobe where the dish openings compatibly receive three dishes in spaced triangular relation to each other, the housing further including a top and a bottom and sidewalls; and,
Where the dishes include a dish body and a dish lip, where the dish body is insertable into a dish opening in the housing, where the housing includes a dish collar formed about the perimeter of dish opening, and where the dish lip is fittable onto the dish collar and the dish is thereafter affirmatively retained to the housing.

8. The pet food tray of claim Number 7, where the housing includes a tray lip formed around the perimeter of the top of the housing to inhibit the loss of pet food from the pet food tray.

9. The pet food tray of claim Number 7, where the dish lip further includes a lip edge and the dish collar further includes an outer edge, where the dish lip forms a space between the dish lip and the dish body and where said dish is reversibly engaged with the outer edge of the dish collar by fitting the lip edge around the outer edge and thereby affirmatively retaining the dish collar within said space.

10. The pet food tray of claim Number 7, where the dishes are comprised of sealed containers of prepared pet food products that are compatibly installable in the dish openings in the housing.

11. A pet food tray for presenting food to a domestic pet, the pet food tray comprising:
Dishes for holding pet food; and,
A housing with three lobes with dish opening in each lobe where the dish openings compatibly receive three dishes in spaced triangular relation to each other, the housing further including a top and a bottom and sidewalls; and,
Where the dishes include a dish body and a dish lip, where the dish body is insertable into a dish opening in the housing, where the housing includes a dish collar formed about the perimeter of dish opening, and the dish lip further includes a lip edge and the dish collar further includes an outer edge, where the dish lip forms a space between the dish lip and the dish body and where said dish is reversibly engaged with the outer edge of the dish collar by fitting the lip edge around the outer edge and thereby affirmatively retaining the dish collar within said space.

12. The pet food tray of claim Number 11, where the housing includes a tray lip formed around the perimeter of the top of the housing of sufficient height to inhibit pet food from being discharged from the pet food tray.

13. The pet food tray of claim Number 11, where the dishes are comprised of disposable sealed containers of prepared pet food products that are compatibly installable in the dish openings in the housing.

14. The pet food tray of claim Number 11, where the dishes are fabricated from plastic.

15. The pet food tray of claim Number 11, where the housing is fabricated from stainless steel.

16. The pet food tray of claim Number 11, where the housing includes finger holes use in handling the pet food tray.

17. The pet food tray of claim Number 11, where the bottom of the housing includes feet for gripping a floor.
